(19) United States
(12) Patent Application Publication
(10) Pub. No.: US 2020/0364845 A1
(43) Pub. Date: Nov. 19, 2020

(54) SYSTEMS AND METHODS FOR IDENTIFYING AND ADDRESSING RENDERING ARTIFACTS

(71) Applicant: Global Graphics Software Limited, Cambridge (GB)

(72) Inventor: Dean Edis, Cambridgeshire (GB)

(21) Appl. No.: 16/413,383

(22) Filed: May 15, 2019

(51) Int. Cl. G06T 7/00; G06T 5/00

(52) U.S. Cl. CPC G06T 7/0002; G06T 5/002; G06F 3/04847; G06T 2207/20092; G06T 2207/30168; G06T 2207/20081

(57) ABSTRACT

Systems and methods for detecting rendering artifacts utilize an artifact detection engine stored in the memory, the artifact detection engine configured to identify rendering artifacts based on training of the artifact detection engine using a set of training images. An optional artifact remediation engine configured to alter one or more rendering parameters and then generate a new rendered image can also be included.

### FIELD

The invention relates to systems and method for identifying rendering artifacts and correcting or reducing the artifacts. The invention also relates to systems and methods for automatically detecting and correcting or reducing rendering artifacts.

### BACKGROUND

When using a screening algorithm to reduce the color depth of an image, rendering artifacts can occur in the output image. Detecting such issues, and resolving them, can be time consuming especially when different images or portions of an image (skin tones, vector artwork, or the like) may present different artifacts.

### BRIEF SUMMARY

One embodiment is a system for detecting rendering artifacts that includes a display device; one or more memory devices that store instructions; an artifact detection engine stored in the memory, the artifact detection engine configured to identify rendering artifacts based on training of the artifact detection engine using a set of training images, wherein a portion of the training images contained at least one rendering artifact; and one or more processor devices that execute the stored instructions to perform actions, including: obtaining a rendered image; inputting the rendered image into the artifact detection engine; determining, using the artifact detection engine, whether the rendered image includes at least one rendering artifact; displaying, on the display device, the rendered image; and indicating, on the display of the rendered image, the at least one rendering artifact when the rendered image is determined to include the at least one rendering artifact.

In at least some embodiments, the instructions further include receiving a source image; and rendering the source image to produce the rendered image. In at least some embodiments, the instructions further include in response to user input when the rendered image is determined to include the at least one rendering artifact, modifying one or more rendering parameters; and rendering the source image or rendered image to produce a new rendered image. In at least some embodiments, the instructions further include inputting the new rendered image into the artifact detection engine; determining, using the artifact detection engine, whether the new rendered image includes at least one rendering artifact; displaying, on the display device, the new rendered image; and indicating, on the display of the new rendered image, the at least one rendering artifact when the new rendered image is determined to include the at least one rendering artifact.

In at least some embodiments, the system further includes an artifact remediation engine stored in the memory, the artifact remediation engine configured to alter one or more rendering parameters and then generate a new rendered image.

In at least some embodiments, the instructions further include in response to user input when the rendered image is determined to include the at least one rendering artifact, modifying one or more rendering parameters using the artifact remediation engine; and rendering the source image or rendered image to produce a new rendered image. In at least some embodiments, the instructions further include inputting the new rendered image into the artifact detection engine; determining, using the artifact detection engine, whether the new rendered image includes at least one rendering artifact; displaying, on the display device, the new rendered image; and indicating, on the display of the new rendered image, the at least one rendering artifact when the new rendered image is determined to include the at least one rendering artifact.

In at least some embodiments, the instructions further include in response to determining that the rendered image includes the at least one rendering artifact, automatically modifying one or more rendering parameters using the artifact remediation engine; and rendering the source image or rendered image to produce a new rendered image. In at least some embodiments, the instructions further include inputting the new rendered image into the artifact detection engine; determining, using the artifact detection engine, whether the new rendered image includes at least one rendering artifact; displaying, on the display device, the new rendered image; and indicating, on the display of the new rendered image, the at least one rendering artifact when the new rendered image is determined to include the at least one rendering artifact.

Another embodiment is a method for detecting rendering artifacts that includes providing an artifact detection engine configured to identify rendering artifacts based on training of the artifact detection engine using a set of training images, wherein a portion of the training images contained at least one rendering artifact; obtaining a rendered image; inputting the rendered image into the artifact detection engine; determining, using the artifact detection engine, whether the rendered image includes at least one rendering artifact; displaying the rendered image; and indicating, on the display of the rendered image, the at least one rendering artifact when the rendered image is determined to include the at least one rendering artifact.

In at least some embodiments, the method further includes receiving a source image; and rendering the source image to produce the rendered image. In at least some embodiments, the method further includes in response to user input when the rendered image is determined to include the at least one rendering artifact, modifying one or more rendering parameters; and rendering the source image or rendered image to produce a new rendered image. In at least some embodiments, the method further includes inputting the new rendered image into the artifact detection engine; determining, using the artifact detection engine, whether the new rendered image includes at least one rendering artifact; displaying the new rendered image; and indicating, on the display of the new rendered image, the at least one rendering artifact when the new rendered image is determined to include the at least one rendering artifact.

In at least some embodiments, the method further includes providing an artifact remediation engine configured to alter one or more rendering parameters and then generate a new rendered image.

In at least some embodiments, the method further includes, in response to user input when the rendered image is determined to include the at least one rendering artifact, modifying one or more rendering parameters using the artifact remediation engine; and rendering the source image or rendered image to produce a new rendered image. In at least some embodiments, the method further includes inputting the new rendered image into the artifact detection engine; determining, using the artifact detection engine, whether the new rendered image includes at least one rendering artifact; displaying the new rendered image; and indicating, on the display of the new rendered image, the at least one rendering artifact when the new rendered image is determined to include the at least one rendering artifact.

In at least some embodiments, the method further includes, in response to determining that the rendered image includes the at least one rendering artifact, automatically modifying one or more rendering parameters using the artifact remediation engine; and rendering the source image or rendered image to produce a new rendered image. In at least some embodiments, the method further includes inputting the new rendered image into the artifact detection engine; determining, using the artifact detection engine, whether the new rendered image includes at least one rendering artifact; displaying the new rendered image; and indicating, on the display of the new rendered image, the at least one rendering artifact when the new rendered image is determined to include the at least one rendering artifact.

A further embodiment is a non-transitory computer-readable medium having stored thereon: an artifact detection engine configured to identify rendering artifacts based on training of the artifact detection engine using a set of training images, wherein a portion of the training images contained at least one rendering artifact; and instructions for execution by a processor, including: obtaining a rendered image; inputting the rendered image into the artifact detection engine; determining, using the artifact detection engine, whether the rendered image includes at least one rendering artifact; displaying the rendered image; and indicating, on the display of the rendered image, the at least one rendering artifact when the rendered image is determined to include the at least one rendering artifact.

In at least some embodiments, the non-transitory computer-readable medium has further stored thereon an artifact remediation engine configured to alter one or more rendering parameters and then generate a new rendered image.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a schematic representation of one embodiment of a computing or printing device;

FIG. 2 is a schematic representation of one embodiment of an environment in which the invention can be employed;

FIGS. 3A to 3D illustrate different types of rendering artifacts;

FIG. 4 is flowchart of one embodiment of a method of detecting rendering artifacts;

FIG. 5 is one embodiment of a display of a rendered image with detected rendering artifacts;

FIG. 6 is flowchart of one embodiment of a method of detecting and remediating rendering artifacts;

FIG. 7A illustrates a region with a worming artifact; and

FIG. 7B illustrates the region that has been modified using serpentine screening to address the worming artifact.

### DETAILED DESCRIPTION

The invention relates to systems and method for identifying rendering artifacts and correcting or reducing the artifacts. The invention also relates to systems and methods for automatically detecting and correcting or reducing rendering artifacts.

The methods, systems, and devices described herein may be embodied in many different forms and should not be construed as limited to the embodiments set forth herein. Accordingly, the methods, systems, and devices described herein may take the form of an entirely hardware embodiment, an entirely software embodiment or an embodiment combining software and hardware aspects. The following detailed description is, therefore, not to be taken in a limiting sense. The methods described herein can be performed using any type of processor and any suitable type of device that includes a processor.

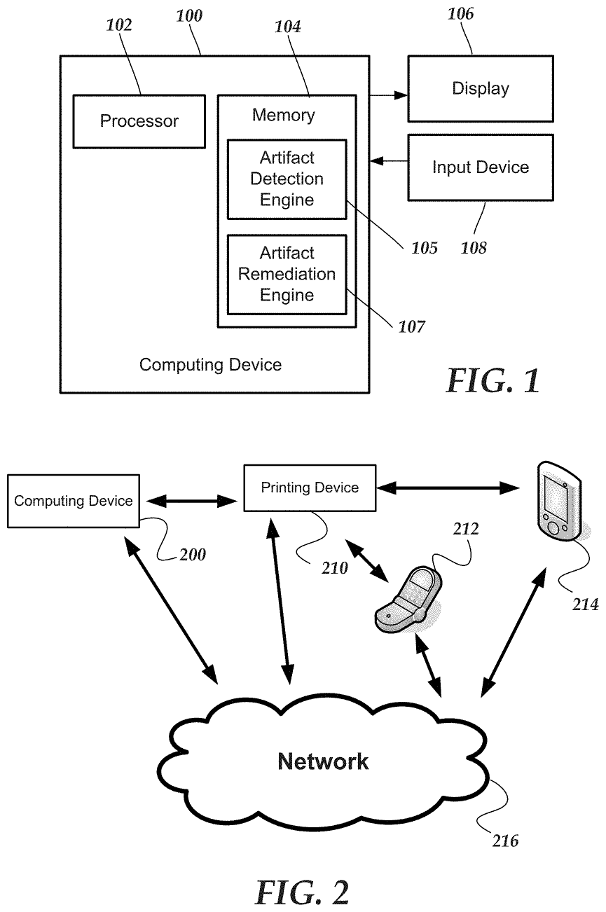

FIG. 1 illustrates one embodiment of a computing device 100 which can be used for identifying and correcting or reducing rendering artifacts. In at least some embodiments, the computing device 100 can be a printing device or part of a printing device or coupled wirelessly, through a local or non-local network, or by wire to a printing device. The computing device 100 includes a processor 102 and a memory 104 and can be attached to one or more of an optional display 106 or an optional input device 108.

The computing device 100 can be, for example, a laptop computer, desktop computer, printing press, printer, tablet, mobile device, smartphone or any other device that can run applications or programs, or any other suitable device for processing information. The computing device 100 can be entirely local to the user or can include components that are non-local to the user including one or both of the processor 102 or memory 104 (or portions thereof). For example, in some embodiments, the user may operate a terminal that is connected to a non-local computer. In some embodiments, the memory can be non-local to the user.

The computing device 100 can utilize any suitable processor 102 including one or more hardware processors that may be local to the user or non-local to the user or other components of the computing device. The processor 102 is configured to execute instructions provided to the processor.

Any suitable memory 104 can be used for the computing device 100. The memory 104 illustrates a type of computer-readable media, namely computer-readable storage media. Computer-readable storage media may include, but is not limited to, nonvolatile, non-transitory, removable, and non-removable media implemented in any method or technology for storage of information, such as computer readable instructions, data structures, program modules, or other data. Examples of computer-readable storage media include RAM, ROM, EEPROM, flash memory, or other memory technology, CD-ROM, digital versatile disks (“DVD”) or other optical storage, magnetic cassettes, magnetic tape, magnetic disk storage or other magnetic storage devices, or any other medium which can be used to store the desired information and which can be accessed by a computing device.

Communication methods provide another type of computer readable media; namely communication media. Communication media typically embodies computer-readable instructions, data structures, program modules, or other data in a modulated data signal such as a carrier wave, data signal, or other transport mechanism and include any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

The memory 104 includes instructions that can be executed in the processor 102. The memory may also include instructions that constitute a variety of different software engines. For example, the memory 104 can include an artifact detection engine 105 and an artifact remediation engine 107, which are described in more detail below. In at least some embodiments, any of these engines may be referred to as a module or logic.

The display 106 can be any suitable display device, such as a monitor, screen, display, or the like. The input device 108 can be, for example, a keyboard, mouse, touch screen, track ball, joystick, voice recognition system, or any combination thereof, or the like and can be used by the user to interact with a user interface.

FIG. 2 illustrates one embodiment of a network environment. It will be understood that the network environment includes a network 216 that can be a local area network, a wide area network, the Internet, or any combination thereof. It will also be understood that the network can include devices, other than those illustrated, coupled to the network and that there may be multiple devices of each type illustrated connected to the network. The environment includes a network 216 to which is attached, either directly or through other devices, one or more computing devices 200 (e.g., computers, workstations, servers, or the like), one or more printing devices 210 (such as a printing press, printer, or the like), or any combination of these devices. A computing device 200 can be a printing device or can be directly connected to a printing device 210 or can be connected to a printing device 210 via the network 216. Other devices can optionally be attached to the network such as cellular telephones 212, personal data assistants (PDA's) or tablets 214, portable storage devices (not shown) such as, e.g., compact discs, DVDs, memory sticks, flash drives, or other optical or magnetic storage media, and the like. Any of these devices can be connected directly to the network 216 or via another device such as a computing device 200. Methods of communication can include both wired and wireless (e.g., RF, optical, Wi-Fi, Bluetooth™, or infrared or the like) communications methods and such methods provide another type of computer readable media; namely communication media.

A source image is provided to, obtained by, or generated by a computing device. The term “image”, unless otherwise indicated, refers to any printable material and includes, but is not limited to, pictures, drawings, text, any other graphical elements, and the like and any combination thereof. The source image is processed or rendered to generate a rendered image that can be printed using a selected printing device. As an example of rendering, halftoning is a process by which continuous-tone imagery is approximated on a printing device through the use of drops or dots that may vary in size, spacing, or both. The tiny halftone dots are blended into smooth tones by the human eye. Halftoning can also be used to provide continuous-tone colors using only a limited number of discrete colors. There are a variety of other techniques that can be used to render an image into a printable, rendered image. Any of these techniques, or combination of techniques, can be used to produce the rendered image.

Error Diffusion Screening (EDS) is one example of a halftoning technique that can reduce the color depth of an image by using a seemingly random pattern of predefined dot colors. Error diffusion screening algorithms typically include various different parameters to change the dot pattern produced. When using such a screening algorithm, rendering artifacts can occur in the rendered image.

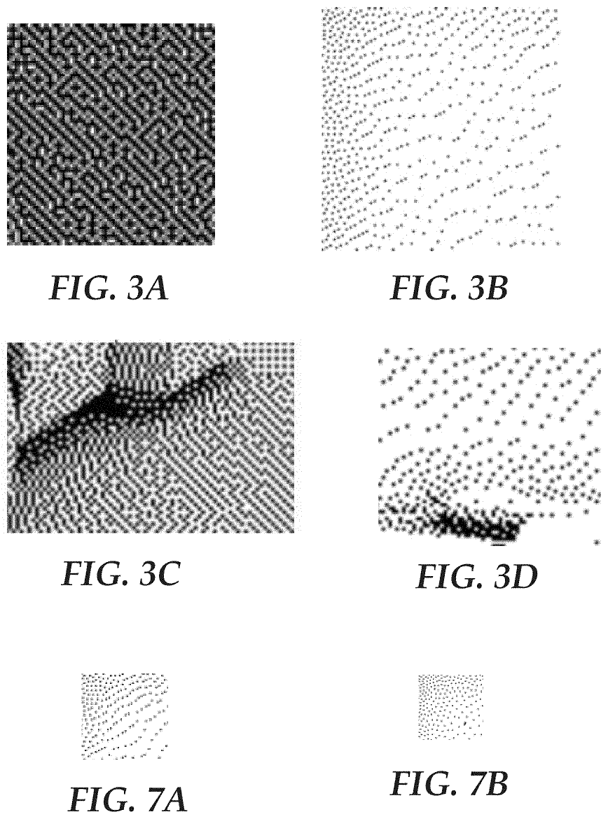

Examples of artifacts include, but are not limited to, dots forming recognizable lines (or other shapes) in the rendered image, as illustrated in FIG. 3A, or a dot pattern appearing less ‘random’, as illustrated in FIG. 3B. The artifact in FIG. 3A is often seen in darker areas of a rendered image, and the artifact in FIG. 3B is often seen in lighter areas of the rendered image. The patterns arise from a pseudo-random process, but these artifacts may appear, when viewed, to produce a feature (e.g., a line or an order to the dots) that is not present in the original source image. FIG. 3C illustrates another artifact—a ‘maze-like’ pattern in the lower-right corner of the rendered image. FIG. 3D illustrates a ‘worming’ artifact which includes visually apparent lines of pixels. Other types of unwanted patterning and artifacts may also arise in the rendered image.

Visually detecting these artifacts, and resolving them, can be time consuming and difficult; particularly when different images or regions of the same image may present different artifacts.

In contrast to manual detection of the artifacts, an artifact detection engine 105 (FIG. 1), as described herein, can be used by a computing device 100 to automatically scan and detect artifacts in a rendered image. In at least some embodiments, an artifact remediation engine 107 can also be used to alter the rendered image to reduce or eliminate the detected artifact or artifacts.

The artifact detection engine 105 utilizes an artifact detection algorithm. The artifact detection engine is configured to identify rendering artifacts based on training of the artifact detection engine using a set of training images. Machine learning and artificial intelligence techniques for modifying and refining an algorithm using a set of training input, such as the training images, are known. Any suitable machine learning or artificial intelligence techniques, or combination of techniques, can be used to train the artifact detection algorithm of the artifact detection engine. Examples of machine learning and artificial intelligence techniques include, but are not limited to, supervised and unsupervised machine learning and artificial intelligence techniques, such as, for example, Bayesian networks, support vector machines (SVMs), neural networks, genetic algorithms, or the like. These techniques may utilize classification, regression, backpropagation, or the like.

In some embodiments, the artifact detection engine includes a machine learning engine or artificial intelligence engine to permit a user to further train or otherwise modify the artifact detection engine. In other embodiments, the artifact detection engine is the result of training using the machine learning or artificial intelligence technique(s), but does not include either engine to provide further training.

The training can include provision of one or more sets of training images. In at least some embodiments, each set includes a large number of training images and the training images includes images without rendering artifacts and images with rendering artifacts. The training images can be labeled prior to, or after, providing the images. For example, each of the images can be initially labeled as “artifact” or “no artifact” or the images can be labeled by a user after providing the images. In at least some embodiments, the images containing an artifact may be labeled with the name of the artifact or other identification that distinguishes between different types of artifacts. This training data may be specific to one screening or rendering method (for example, error diffusion screening), or may be suitable for identifying rendering artifacts for two or more screening or rendering methods.

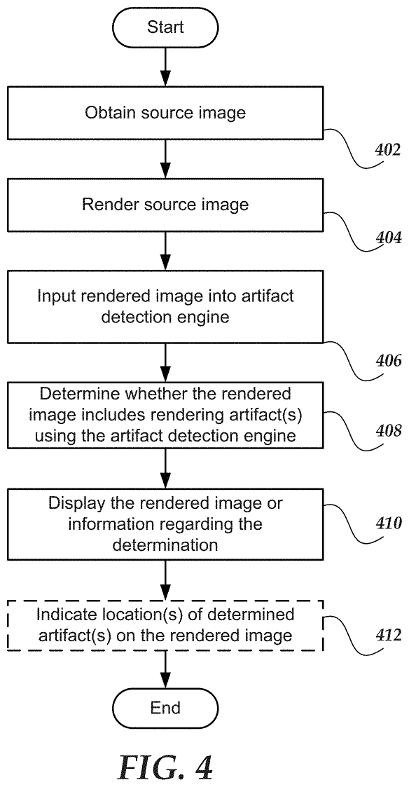

FIG. 4 illustrates one embodiment of a method for identifying rendering artifacts using an artifact detection engine. In at least some embodiments, this method can be implemented using the computing device 100 of FIG. 1. In step 402 of FIG. 4, a source image is obtained by the computing device. The source image can be received from a user, a network source, another computing device or printing device, or from any other source. Alternatively, in at least some embodiments, the source image is obtained by generating the source image on the computing device.

In step 404, the source image is rendered. Any suitable rendering technique can be used. In some embodiments, the source image may be obtained and rendered by a different computing device and then delivered or otherwise sent to a computing device containing the artifact detection engine.

In step 406, the rendered image is input into the artifact detection engine. In step 408, the artifact detection engine applies an artifact detection algorithm to analyze the rendered image and determine whether the rendered image contains any rendering artifacts. The artifact detection algorithm may use any suitable technique or method to analyze the input (i.e., the rendered image.) In some embodiments, the artifact detection algorithm may analyze the rendered image as whole. In other embodiments, the artifact detection engine may divide the input into a grid of windows with a size of x by y pixels and then analyze each window individually. In other embodiments, then artifact detection engine may define a ‘moving window’ of x by y pixels which transitions over the input. The size of the window is selected to be sufficiently large to reliably identify artifacts within the window.

In at least some embodiments, the artifact detection engine will convert the input (or a portion or window from the input) into numerical values representing pixel density. As an example, each pixel may be represented by 0.0 for black, 0.5 for gray, and 1.0 for white.

In at least some embodiments, the artifact detection algorithm may determine 1) the presence of an artifact or 2) the likelihood or probability that an artifact is present. In some embodiments where the artifact detection algorithm is trained to individually identify different types of artifacts, the artifact detection algorithm may determine 1) the presence of one or more specific types of artifacts or 2) the likelihood or probability that one or more specific types of artifacts are present.

In at least some embodiments, the output from the artifact detection engine can be a value or values indicating the level of artifacts in the input (or a window or portion of the input.) For example, the output may be 0.0 for unacceptable, 0.5 for acceptable, or 1.0 little or no artifacts. In other artifacts, the output may indicate the presence or likelihood/probability of artifacts (either in general or by type of artifact).

In at least some embodiments, the artifact detection engine can identify regions of the rendered image that contain or are likely to contain one or more artifacts.

In step 410, the rendered image or information regarding the determination (or both) is displayed. For example, information may be displayed about whether the rendered image contains, or is likely to contain, one or more artifacts and, in some embodiments, may identify which type(s) of artifacts that the rendered image may contain or not contain.

In optional step 412, the location(s) of determined artifact(s) are displayed on the rendered image. In some embodiments, variation in the color, texture, tint, shade, or other suitable feature of the display may indicate which locations within the rendered image contain, or are likely to contain, artifacts.

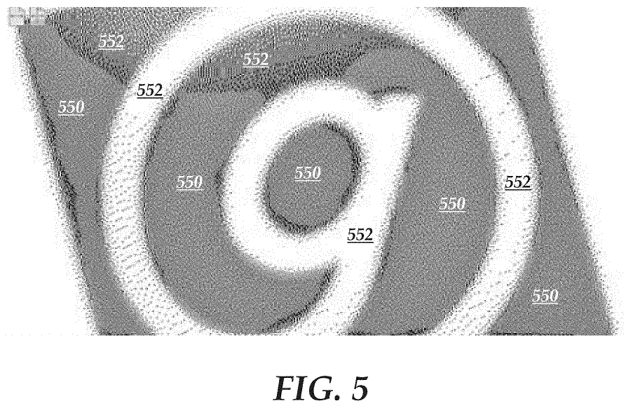

FIG. 5 illustrates one embodiment of a user interface presenting one embodiment of an output of an artifact detection engine. In this display of the rendered image, regions 550 are indicated as containing artifacts and regions 552 do not contain artifacts.

Screening algorithms often contain parameters than can be modified, resulting in changes in the rendered image. As an example, in at least some embodiments of error diffusion screening (EDS) there can be one or more of a) a weight matrix that is used for propagating pixel errors to surrounding pixels, b) perturbations which add random fluctuations to the pixels in order to reduce recurring patterns, or c) serpentine screening which alternates the processing of lines in the source image so that the lines are processed alternating from left-to-right, then right-to-left. As an example of modifications that can be made for EDS, the weight matrix can be adjustable. In many instances, EDS is performed starting from well-known weight matrices. ‘Floyd Steinberg’ and ‘Stucki’ are a some of the more famous examples of weight matrices which are known to produce reasonable output in most cases.

In at least some embodiments, an adjustment of parameters for the screening method can be used to modify the rendered image, or regions of the rendered image, that are identified by the artifact detection engine as containing artifacts. In at least some embodiments, an artifact remediation engine can be used to modify the rendered image to reduce rendering artifacts and produce a new rendered image. In at least some embodiments, the artifact remediation engine is automatically engaged when the artifact detection engine indicates that the rendered image includes artifacts. In other embodiments, the artifact remediation engine can be engaged when directed by a user.

In some embodiments, the artifact remediation engine may only modify regions of the rendered image that contain, or are likely to contain, artifacts. In other embodiments, the artifact remediation engine may modify the entire image or selected portions of the image.

In some embodiments, the new rendered image arising from the modifications using the artifact remediation engine can be input again into the artifact detection engine for analysis to determine whether the new rendered image includes rendering artifacts. In some embodiments, a loop utilizing the artifact detection engine and artifact remediation engine can be formed and continued until, for example, no artifacts are identified or the level, severity, or size of artifacts is at or below a threshold.

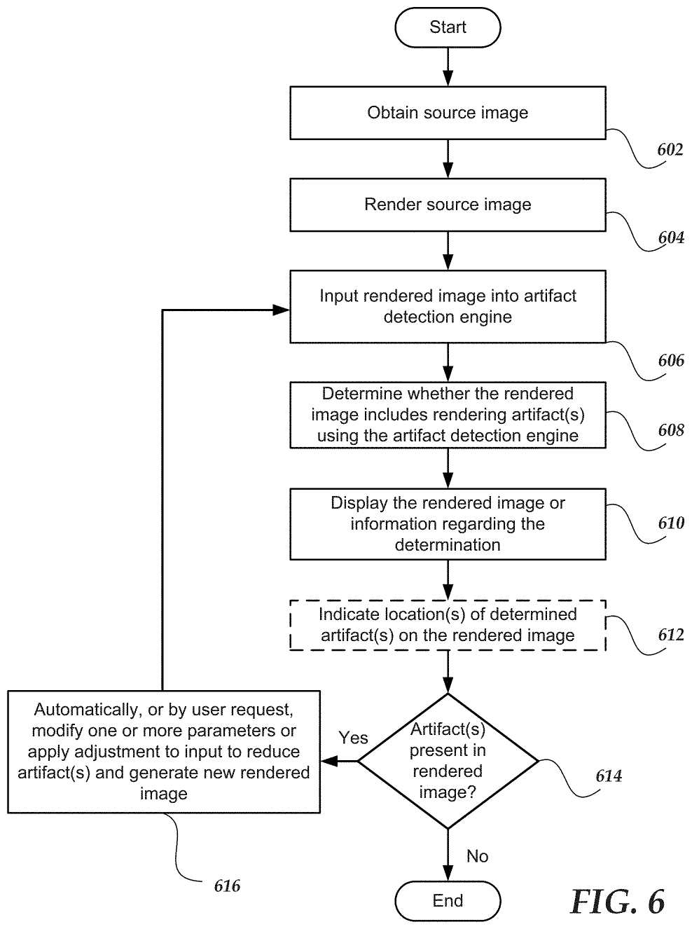

FIG. 6 is one embodiment of a process for identifying and remediating artifacts. Steps 602 to 612 are the same as steps 402 to 412 of FIG. 4.

In step 614, the system or a user determines if artifact(s) are present in the rendered image. If the user makes the determination, then the system proceeds according to the user's direction. If the system makes the determination, the system's response may be based on a determination of whether the artifact(s) are present at a level, severity, or size that is at or below a threshold or the response may be based on a simple determination of whether artifact(s) are present or not. If not, the process ends.

In at least some embodiments, the system or user may determine whether the detected artifacts are significant or not. For example, the system or user may determine whether a human observer is likely to notice the artifact. As an example, if the dots are light yellow on a white media, the human eye is less likely to detect an artifact and, therefore, the artifact may be deemed insignificant and below a threshold for addressing the artifact.

In at least some embodiments, an artifact might be considered below a threshold if the artefact is not in an ‘important’ (which may be a subjective determination) area of the image. Inversely, addressing an artifact in the area of a photo of a face might be considered more ‘important’ that those in a background, as the human brain tends to focus much more on faces. In at least some embodiments, a threshold applied by a user or the system could be based on the context of the image and location of the artifact.

If an artifact is present, in step 616, one or more parameters of the rendering technique(s) can be modified and the source image (or rendered image) can be rendered using the modified parameters to generate a new rendered image. In at least some embodiments, the new rendered image is input to the artifact detection engine and steps 606 to 614 are performed.

In some embodiments, the modification is performed automatically. For example, the artifact remediation engine can include instructions for making modifications based on the type, size, severity, or other features of the artifact. For example, the artifact remediation matrix may select a known weighting matrix or adjust parameters of weighting matrix or adjust a perturbation parameter or employ/halt serpentine screening or any combination of these modifications.

In at least some embodiments, to address the artifacts illustrated in FIGS. 3B and 3D, application of serpentine screening may be the initial modification. FIG. 7A illustrates one example of a worming artifact. FIG. 7B illustrates the application of serpentine screening to remove the worming artifact. Adding perturbation (e.g., adding random noise to the source image) may also address the artifacts.

In at least some embodiments, to address the artifacts illustrated in FIGS. 3A and 3C, adjustment of the EDS weight matrix may be the initial modification. How to adjust the weigh matrix and by what amount may depend on the severity of the artifact and the current weight matrix being used.

In some of these embodiments, steps 606 to 616 can form a feedback loop to adjust the rendering parameters based on previous rendered images.

In other embodiments, the modifications may be performed at user request. In some of these embodiments, the system may determine the specific type or values for the modifications. In other embodiments, the system may request or require input of the type or values for the modifications from the user.

In some embodiments, either or both of steps 610 and 612 may be skipped during processing of a rendered image and the system may automatically perform steps 614 and 616 without user intervention and continue performing the process until an acceptable rendered image is achieved. In some of these embodiments, the system may also halt processing if little or no improvement is made or there is a failure to converge on a rendered image without artifacts (or with an acceptable level of artifacts).

In some embodiments, the rendering parameters that are determined to produce an acceptable rendered image may be stored in the memory 104 and applied to subsequent rendering of other source images.

By applying the artifact detection engine to analyze rendered images to automatically identify regions which might contain rendering artifacts time and money can be saved. In at least some embodiments, advantages can be achieved including, but not limited to, one or more of the following: a) quickly giving feedback to a user which images, and regions within those images, could contain rendering artifacts and b monitoring changes to the rendered images as the parameters in the screening algorithm are perturbed. Examples of modifications include, but are not limited to, modifying the weight matrix in EDS screens, adding perturbations, and toggling serpentine scanning.

It will be understood that each block of the flowchart illustration, and combinations of blocks in the flowchart illustration and methods disclosed herein, can be implemented by computer program instructions. These program instructions may be provided to a processor to produce a machine, such that the instructions, which execute on the processor, create means for implementing the actions specified in the flowchart block or blocks disclosed herein. The computer program instructions may be executed by a processor to cause a series of operational steps to be performed by the processor to produce a computer implemented process. The computer program instructions may also cause at least some of the operational steps to be performed in parallel. Moreover, some of the steps may also be performed across more than one processor, such as might arise in a multi-processor computing device. In addition, one or more processes may also be performed concurrently with other processes, or even in a different sequence than illustrated without departing from the scope or spirit of the invention.

The computer program instructions can be stored on any suitable computer-readable medium including, but not limited to, RAM, ROM, EEPROM, flash memory or other memory technology, CD-ROM, digital versatile disks (“DVD”) or other optical storage, magnetic cassettes, magnetic tape, magnetic disk storage or other magnetic storage devices, or any other medium which can be used to store the desired information and which can be accessed by a computing device.

The above specification and examples provide a description of the invention. Since many embodiments of the invention can be made without departing from the spirit and scope of the invention, the invention also resides in the claims hereinafter appended.

1. A system for detecting rendering artifacts, the system comprising:
a display device;
one or more memory devices that store instructions;
an artifact detection engine stored in the memory, the artifact detection engine configured to identify rendering artifacts based on training of the artifact detection engine using a set of training images, wherein a portion of the training images contained at least one rendering artifact; and
one or more processor devices that execute the stored instructions to perform actions, including:
obtaining a printable image that has been rendered from a source image using a halftoning process to produce the printable image for printing on a printing device;
inputting the printable image into the artifact detection engine;
determining, using the artifact detection engine, whether the printable image includes at least one rendering artifact arising due to the halftoning process;
displaying, on the display device, the printable image; and
indicating, on the display of the printable image, the at least one rendering artifact when the printable image is determined to include the at least one rendering artifact.

2. The system of claim 1, wherein the instructions further include
receiving the source image; and
rendering using the halftoning process the source image to produce the printable image.

3. The system of claim 2, wherein the instructions further include
in response to user input when the printable image is determined to include the at least one rendering artifact, modifying one or more rendering parameters of the halftoning process; and
rendering the source image or printable image using the halftoning process with the modified one or more rendering parameters to produce a new printable image.

4. The system of claim 3, wherein the instructions further include
inputting the new printable image into the artifact detection engine;
determining, using the artifact detection engine, whether the new printable image includes at least one rendering artifact;
displaying, on the display device, the new printable image; and
indicating, on the display of the new printable image, the at least one rendering artifact when the new printable image is determined to include the at least one rendering artifact.

5. The system of claim 2, further comprising an artifact remediation engine stored in the memory, the artifact remediation engine configured to alter one or more rendering parameters of the halftoning process and then generate a new printable image.

6. The system of claim 5, wherein the instructions further include
in response to user input when the printable image is determined to include the at least one rendering artifact, modifying one or more rendering parameters of the halftoning process using the artifact remediation engine; and
rendering the source image or printable image to produce a new printable image.

7. The system of claim 6, wherein the instructions further include
inputting the new printable image into the artifact detection engine;
determining, using the artifact detection engine, whether the new printable image includes at least one rendering artifact;
displaying, on the display device, the new printable image; and
indicating, on the display of the new printable image, the at least one rendering artifact when the new printable image is determined to include the at least one rendering artifact.

8. The system of claim 5, wherein the instructions further include
in response to determining that the printable image includes the at least one rendering artifact, automatically modifying one or more rendering parameters of the halftoning process using the artifact remediation engine; and
rendering the source image or printable image to produce a new printable image.

9. The system of claim 8, wherein the instructions further include
inputting the new printable image into the artifact detection engine;
determining, using the artifact detection engine, whether the new printable image includes at least one rendering artifact;
displaying, on the display device, the new printable image; and
indicating, on the display of the new printable image, the at least one rendering artifact when the new printable image is determined to include the at least one rendering artifact.

10. A method for detecting rendering artifacts, the method comprising:
providing an artifact detection engine configured to identify rendering artifacts based on training of the artifact detection engine using a set of training images, wherein a portion of the training images contained at least one rendering artifact;
obtaining a printable image that has been rendered from a source image using a halftoning process to produce the printable image for printing on a printing device;
inputting the printable image into the artifact detection engine;
determining, using the artifact detection engine, whether the printable image includes at least one rendering artifact;
displaying the printable image; and
indicating, on the display of the printable image, the at least one rendering artifact when the printable image is determined to include the at least one rendering artifact.

11. The method of claim 10, further comprising
receiving the source image; and
rendering using the halftoning process the source image to produce the printable image.

12. The method of claim 11, further comprising
in response to user input when the printable image is determined to include the at least one rendering artifact, modifying one or more rendering parameters of the halftoning process; and
rendering the source image or printable image to produce a new printable image.

13. The method of claim 12, further comprising
inputting the new printable image into the artifact detection engine;
determining, using the artifact detection engine, whether the new printable image includes at least one rendering artifact;
displaying the new printable image; and
indicating, on the display of the new printable image, the at least one rendering artifact when the new printable image is determined to include the at least one rendering artifact.

14. The method of claim 11, further comprising
providing an artifact remediation engine configured to alter one or more rendering parameters of the halftoning process and then generate a new printable image.

15. The method of claim 14, further comprising
in response to user input when the printable image is determined to include the at least one rendering artifact, modifying one or more rendering parameters of the halftoning process using the artifact remediation engine; and
rendering the source image or printable image to produce a new printable image.

16. The method of claim 15, further comprising
inputting the new printable image into the artifact detection engine;
determining, using the artifact detection engine, whether the new printable image includes at least one rendering artifact;
displaying the new printable image; and
indicating, on the display of the new printable image, the at least one rendering artifact when the new printable image is determined to include the at least one rendering artifact.

17. The method of claim 14, further comprising
in response to determining that the printable image includes the at least one rendering artifact, automatically modifying one or more rendering parameters of the halftoning process using the artifact remediation engine; and
rendering the source image or printable image to produce a new printable image.

18. (canceled)

19. A non-transitory computer-readable medium having stored thereon:
an artifact detection engine configured to identify rendering artifacts based on training of the artifact detection engine using a set of training images, wherein a portion of the training images contained at least one rendering artifact; and
instructions for execution by a processor, including:
obtaining a printable image that has been rendered from a source image using a halftoning process to produce the printable image for printing on a printing device;
inputting the printable image into the artifact detection engine;
determining, using the artifact detection engine, whether the printable image includes at least one rendering artifact;
displaying the printable image; and
indicating, on the display of the printable image, the at least one rendering artifact when the printable image is determined to include the at least one rendering artifact.

20. The non-transitory computer-readable medium of claim 19, having further stored thereon:
an artifact remediation engine configured to alter one or more rendering parameters of the halftoning process and then generate a new printable image.

21. The system of claim 1, wherein the artifact detection engine is configured to detect at least one of the following: 1) a dot pattern in the printable image that appears to produce a line or a dot order that is not present in the source image; 2) a maze-like pattern in the printable image that is not present in the source image; or 3) a worming artifact which produces multiple visually apparent lines in the printable image that are not in the source image.
